(19) United States
(12) Patent Application Publication
(10) Pub. No.: US 2002/0186963 A1
(43) Pub. Date: Dec. 12, 2002

(54) Image recording apparatus and method

(75) Inventors: Kenji Toyoda, Chigasaki-shi (JP); Masaharu Itoh, Tokyo (JP)

Correspondence Address: Mitchell W. Shapiro, Miles & Stockbridge P.C., Suite 500, 1751 Pinnacle Drive, McLean, VA, 22102-3833, US

(73) Assignee: Nikon Corporation

(21) Appl. No.: 10/206,355

(22) Filed: Jul. 29, 2002

Related U.S. Application Data
(63) Continuation of application No. 09/467,923, filed on Dec. 21, 1999, now abandoned.
Application No. 09/467,923 is a continuation of application No. 08/932,620, filed on Sep. 17, 1997, now abandoned.

(30) Foreign Application Priority Data
Sep. 17, 1996 (JP) 8-244633

(51) Int. Cl. H04N 5/76; H04N 5/225; H04N 5/781

(52) U.S. Cl. 386/117; 386/125

(57) ABSTRACT

An image recording apparatus and method utilize a preliminary information storage unit and a main information storage unit to record an entire image signal (without missing a head portion) while providing a substantial reduction in power consumption and cumulative operation time of the main storage unit. The main storage unit, such as a disk drive, is kept in an OFF state until a recording operation is initiated. Then, power is supplied to the main storage unit, and the preliminary storage unit, having a relatively low power consumption, records the head portion of the image information while the main storage unit is brought to a stable operating state. After the main storage unit is in the stable state, the information from the preliminary storage unit is recorded in the main storage unit.

This application claims the priority of Japanese Patent Application No. 8-244633 filed Sep. 17, 1996, which is incorporated herein by reference.

### BACKGROUND OF THE INVENTION

1. Field of the Invention

This invention relates to an apparatus and method for recording image information of an image signal, such as an image signal from an electronic camera. The invention is more particularly concerned with an image recording apparatus and method that can record image information of an image signal (which information may include voice and other accompanying information) without missing a head portion of the information.

2. Related Background Art

Image recording apparatus are known in which image information is received from a CCD image pickup device or the like, and the image information is recorded to a dynamic storage medium (a storage medium which requires relative movement with respect to a writing device that records information to the medium), such as a magneto-optical or other type of disk. In such an image recording apparatus, recording of the image information cannot be started until a stable state of relative movement is established between the recording (storage) medium and the writing device-for example, a state in which a disk or a rotary write head is rotated at a constant rate.

In order to start recording image information immediately upon initiation of an image recording operation, the stable state of relative movement between the recording medium and the writing device must be established in advance of the image recording operation. This is accomplished by placing a drive unit that moves the recording medium or the writing device in a stand-by state prior to the recording operation. In the stand-by state, the drive unit is kept ON so that the recording medium and the writing device are already in the stable state of relative movement when the image recording operation is initiated.

If the image recording apparatus operates in the standby state described above for long periods of time, the service life of the drive unit may be adversely affected. Further, if the image recording apparatus is a battery-powered apparatus, such as portable apparatus having a camera unit as an integral part thereof, the power of the battery tends to be rapidly consumed. This results in a short service life of the battery.

It is conceivable that, in order to avoid these problems, the image recording apparatus can be brought into the stand-by state each time the recording operation is initiated. But in this case, no image information can be recorded until the stand-by state is reached. Consequently, the head portion of the image information would be missed.

### SUMMARY OF THE INVENTION

In accordance with one of its principal aspects, the present invention provides an apparatus and method whereby image information of an image signal is recorded in a preliminary storage unit during a first period of time, and whereby, during a subsequent period of time, further image information of the image signal is recorded to a main storage unit, bypassing the preliminary storage unit, and image information from the preliminary storage unit is recorded in the main storage unit. In a preferred mode, the main storage unit records to a dynamic storage medium, such as a disk, and the first period of time is a period in which the main storage unit is brought from an inactive state to a stable operating state for recording image information. As soon as, or some time after, the main storage unit reaches the stable state, the preliminary storage unit is bypassed. By recording to the preliminary storage unit during the first period, the head portion of the image information is recorded while the main storage unit is brought to the stable state for recording information. Thus, the main storage unit need not be maintained in a stand-by state. The preliminary storage unit is advantageously a static storage unit (a unit which does not require relative motion of a recording medium with respect to a writing device in order to record information), such as an electronic buffer memory.

According to one basic viewpoint, an image recording apparatus of the present invention may comprise first recording means having a predetermined operating state in which the first recording means is capable of recording image information of an image signal to an information storage medium, a preliminary storage unit that stores image information of the image signal while the first recording means is being brought to the predetermined operating state, and additional recording means that records the image information stored by the preliminary storage unit to the storage medium after the first recording means has been brought to the predetermined operating state. The first recording means operates to record further image information of the image signal, bypassing the preliminary storage unit, after reaching the predetermined operating state.

According to another basic viewpoint, an image recording apparatus of the invention may comprise a preliminary information storage unit, a main information storage unit, and a control unit. The control unit controls the information storage units such that the preliminary information storage unit records image information of an image signal during a first period of time, and such that, during a subsequent period of time, the main information storage unit records further image information of the image signal, bypassing the preliminary information storage unit, and the main information storage unit records image information from the preliminary information storage unit.

An image recording method of the present invention may, according to one basic viewpoint, comprise generating an image signal, recording image information of the image signal to a preliminary storage medium during a first period of time, and, during a subsequent period of time, recording further image information of the image signal to a main storage medium, bypassing the preliminary storage medium, and recording image information from the preliminary storage medium to the main storage medium.

According to another basic viewpoint, the invention provides an operating method of an image recording apparatus including a camera unit and an information storage unit for recording image information of an image signal from the camera unit on a disk, the method comprising initiating an operation to record image information of the image signal on the disk, activating the information storage unit in response to initiation of the operation, recording image information of the image signal in a buffer unit at least until the information storage unit reaches a stable operating state for recording information to the disk, and after the information storage unit has reached the stable operating state, recording further image information of the image signal on the disk, bypassing the buffer unit, and transferring image information from the buffer unit to the disk.

In accordance with another principal aspect of the invention, the image recording apparatus and method may be designed so that the arrangement of recording areas in which the image information is recorded in the main storage unit is optimized during the recording operation. For example, in one preferred mode, the recording of image information to the preliminary storage unit is continued at a relatively slow rate while image information is transferred to the main storage unit at a relatively fast rate, and the main storage unit commences bypassing the preliminary storage unit when all image information recorded to the preliminary storage unit has been transferred. In another example, a free space is provided in a head region of an area of a storage medium to which image information is recorded when bypassing the preliminary storage unit, and the image data from the preliminary storage unit is recorded in the free space after the bypass recording. In each case, the image information is arranged in chronological order in the main storage unit.

In accordance with yet another principal aspect of the invention, the image recording apparatus and method may be designed to reduce a processing load during recording of image information that must be processed at high speed. In one example, the image information from the preliminary storage unit is recorded in the main storage unit after the bypass recording, and the content of a data management area of a recording medium of the main storage unit that controls read out of information from that medium is changed so that the information from the preliminary storage unit is read out first, followed by the remainder of the image information.

The aforementioned and other aspects of the invention, as well as its various features and advantages, will be better understood upon considering the following detailed description in conjunction with the accompanying drawings.

### BRIEF DESCRIPTION OF THE DRAWINGS

FIGS. 1A and 1B are simplified block diagrams for explaining basic principles of the invention.

FIG. 2 is a simplified block diagram of an apparatus implementing the principles illustrated in FIGS. 1A and 1B.

FIG. 3 is a block diagram showing of an image recording apparatus according to the invention.

FIG. 4 is a perspective view of the apparatus of FIG. 3.

FIG. 5 is a flow chart for explaining the operation of a first embodiment of the invention.

FIG. 6 is a flow chart for explaining the operation of a second embodiment of the invention.

FIG. 7 is a flow chart for explaining the operation of a third embodiment of the invention.

### DETAILED DESCRIPTION OF THE INVENTION

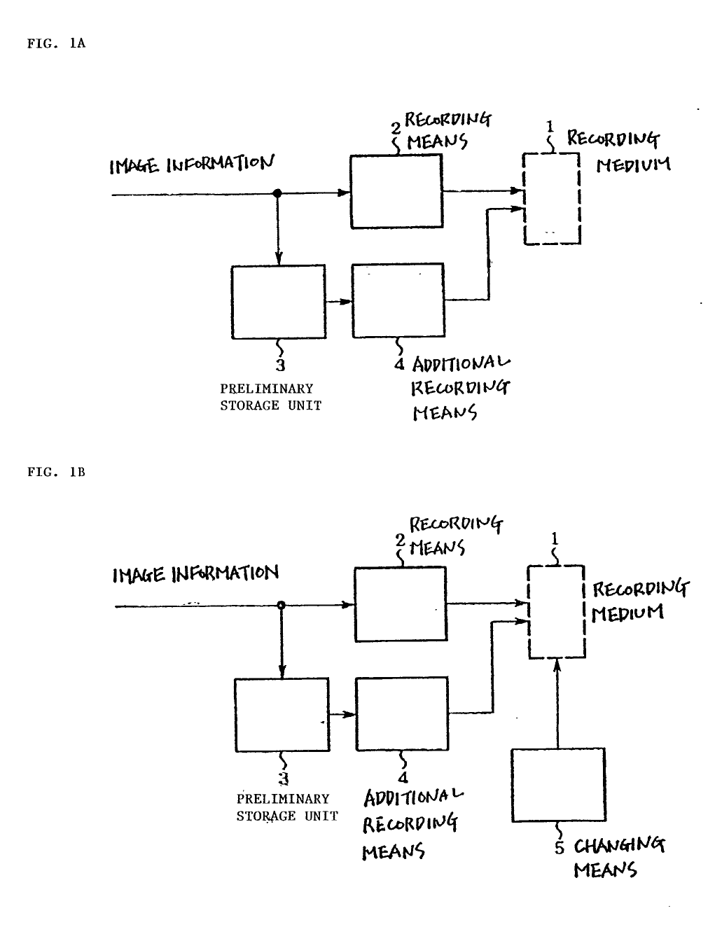

FIG. 1A is a simplified block diagram showing the principles of a preferred mode of the image recording apparatus in accordance with the present invention. As shown in FIG. 1, the image recording apparatus includes recording means 2 for recording image information of an image signal to a recording medium 1, a preliminary storage unit 3, and additional recording means 4 for receiving image information stored in the preliminary storage unit and recording that information to the recording medium 1. The preliminary storage unit operates to store image information during a first period of time, which may be a period in which the recording means 2 is brought to a predetermined operating state, such as from an inactive state to a stable state for recording information. The recording means 2 operates during a subsequent period of time to record further image information of the image signal to the recording medium 1, bypassing the preliminary storage unit 3, and the additional recording means operates to record image information from the preliminary storage unit 3 to the recording medium 1. The recording medium 1 is preferably a dynamic storage medium. In one preferred mode to be described later, the recording means 2 provides a free storage space at the head of a recording area of the recording medium 1 in which the image information is recorded, so as to allow the additional recording means 4 to record the image information from the preliminary storage unit to the free storage space. This arranges the recorded information from the first time period and subsequent time period in chronological order.

FIG. 1B is a simplified block diagram showing the principles of another preferred mode of the invention. The form shown in FIG. 1B is basically the same as that of FIG. 1A, except for the addition of changing means 5. The changing means 5 operates to change a management area of the recording medium 1 that controls an order in which image information is read out from the recording medium. This allows the additional recording means 4 to record information from the preliminary storage unit to the recording medium 1 after the recording operation by the recording means 2 is complete. The changing means changes content of the data management area so that the image information recorded from the preliminary storage unit is read out first, followed by the information recorded directly via the recording means 2.

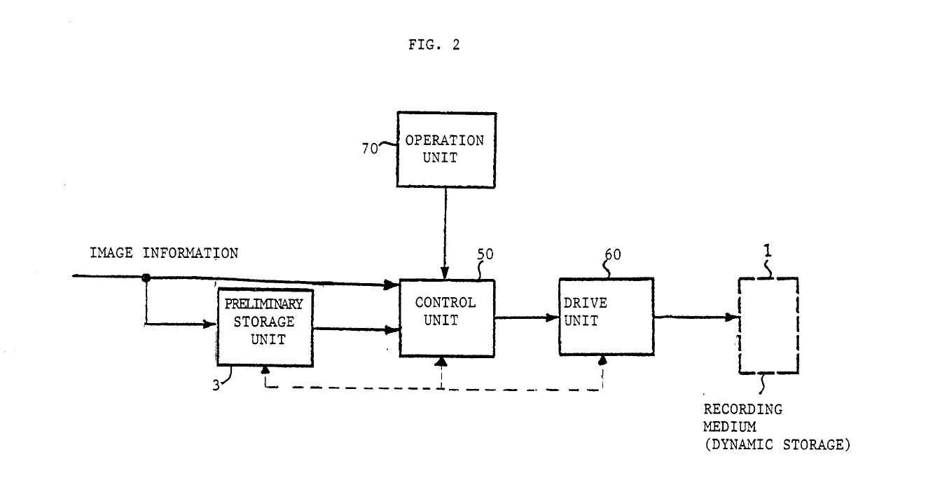

FIG. 2 is a simplified block diagram showing a preferred implementation of the principles exemplified in FIGS. 1A and 1B. In FIG. 2, the recording medium 1 is constituted by a dynamic recording medium, preferably a disk. The preliminary storage unit 3 is preferably a static buffer memory. The recording means 2 and additional recording means 4 are constituted by a control unit 50 and a drive unit 60, which includes a writing device for writing information to the recording medium 1. The drive unit drives the writing device or the recording medium to establish the required relative movement therebetween for recording information, and is preferably a disk drive. An operation unit 70 is connected to the control unit to control the start/stop of the image recording operation. The operation unit may be a manually operable member such as a push button, a touch screen, etc. The control unit 50 controls the operation of the preliminary storage unit and the drive unit.

In the image recording apparatus of FIG. 2, image information received from the outside is supplied directly to the control unit 50 and to the preliminary storage unit 3. Prior to the initiation of a recording operation by the operation unit 70, the drive unit 60 is an OFF state. Upon initiation of the recording operation by the operation unit 70, the control unit 50 activates the drive unit 60 and causes the preliminary storage unit 3 immediately to begin recording the image information. The preliminary storage unit 3 records image information at least until the drive unit 60 has reached a stable operating state for recording information to the recording medium 1. As soon as, or some time after, the drive unit has reached the stable operating state, the control unit passes incoming image information directly to the drive unit 60 for recording to the recording medium 1, bypassing the preliminary storage unit 3. The control unit 50 also separately passes the head portion of the image information, stored in the preliminary storage unit, to the drive unit 60 for recording to the recording medium 1. The timing of this operation in relation to the commencement of bypass recording will depend upon the manner in which the information from the preliminary storage unit 3 is to be recorded to the recording medium 1, as will be evident hereinafter.

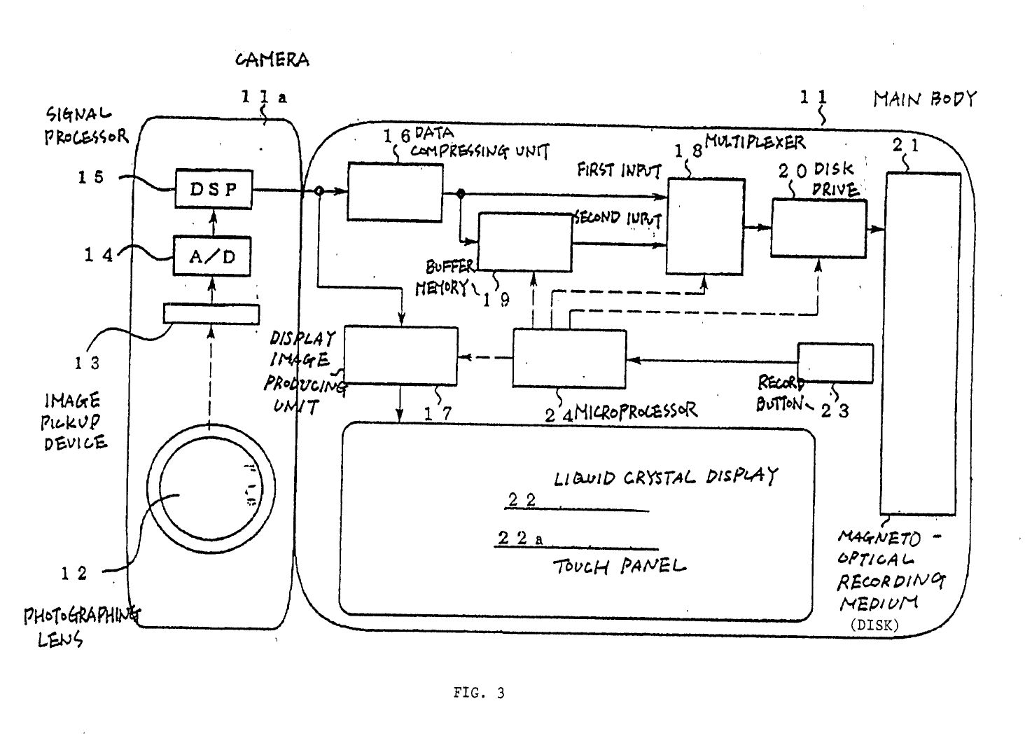

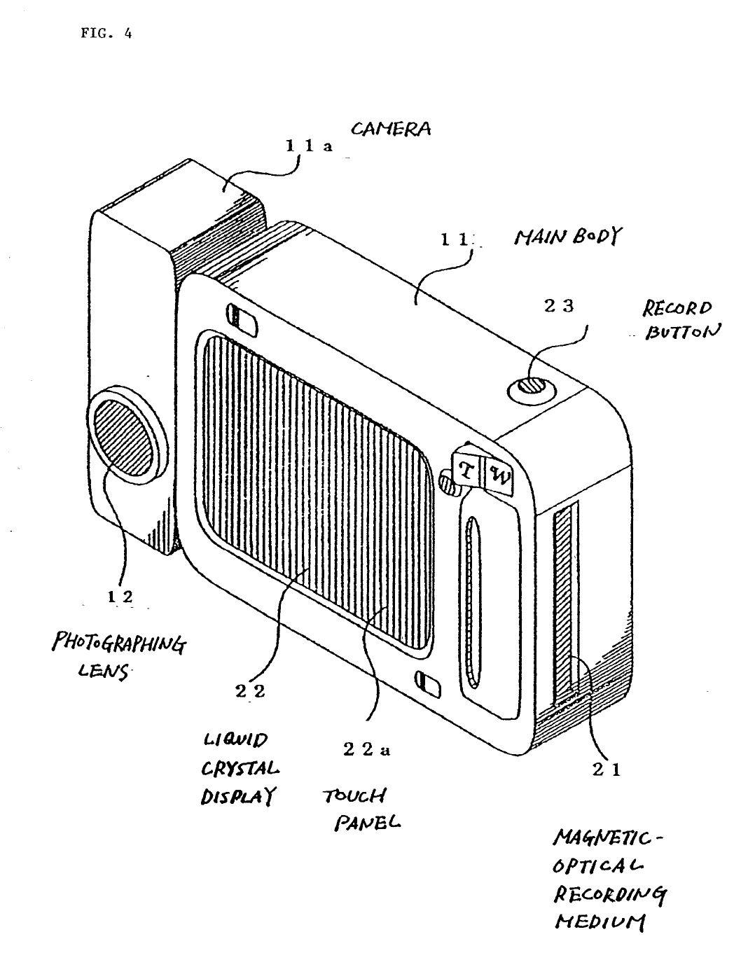

FIG. 3 is a block diagram showing functional elements of an image recording apparatus according to a first embodiment of the present invention. FIG. 4 is a view showing the appearance of the image recording apparatus of the first embodiment. In the form shown, the image recording apparatus constitutes a portable, battery-powered camera system. The combined advantages of reduced cumulative drive operation time and reduced power consumption achieved by the present invention are especially beneficial in the context of battery-powered systems, where the available power supply is limited. However, the invention is not limited to application in such systems.

Referring to FIG. 3 and FIG. 4, a camera 11a is attached to one side face of a main body 11 of the image recording apparatus, and a photographing lens or shooting lens 12 is mounted in the front face of the camera 11a. A beam of light passing through the photographing lens 12 is deflected inside the camera 11a, and reaches the light-receiving plane of an image pickup device 13. The photoelectric output of the image pickup device 13 is connected to a digital signal processor (DSP) 15 via an A/D converter 14.

The output of the signal processor 15 is connected to a data compressing unit 16 and a display image producing unit 17, respectively, and the output of the data compressing unit 16 is connected to the first input of a multiplexer 18 and the input of a static buffer memory 19. The output of the buffer memory 19 is connected to a second input of the multiplexer 18, and the output of the multiplexer 18 is connected to a disk drive 20. The disk drive 20 includes a recording head that is adapted to write data on a magneto-optical recording medium 21.

The image output of the display image producing unit 17 is displayed on a liquid crystal display 22. This liquid crystal display 22 is provided in the rear face of the main body 11, and a touch panel 22a is attached to the entire area of the screen of the display 22.

A record button 23 is provided on the upper face of the main body 11, and the operating state of this record button 23 is received by a microprocessor 24, constituting a control unit, within the main body 11. The microprocessor 24 generates control signals to the display image producing unit 17, buffer memory 19, multiplexer 18, and disk drive 20.

With regard to the relationship between the apparatus shown in FIG. 1A and the first embodiment, the recording means 2 corresponds to the disk drive 20, microprocessor 24 and the circuitry of multiplexer 18 which connects its first input to the output. The preliminary storage unit 3 corresponds to the buffer memory 19, and the additional recording means 4 corresponds to the disk drive 20, microprocessor 24, and the circuitry of the multiplexer which connects its second input terminal to the output.

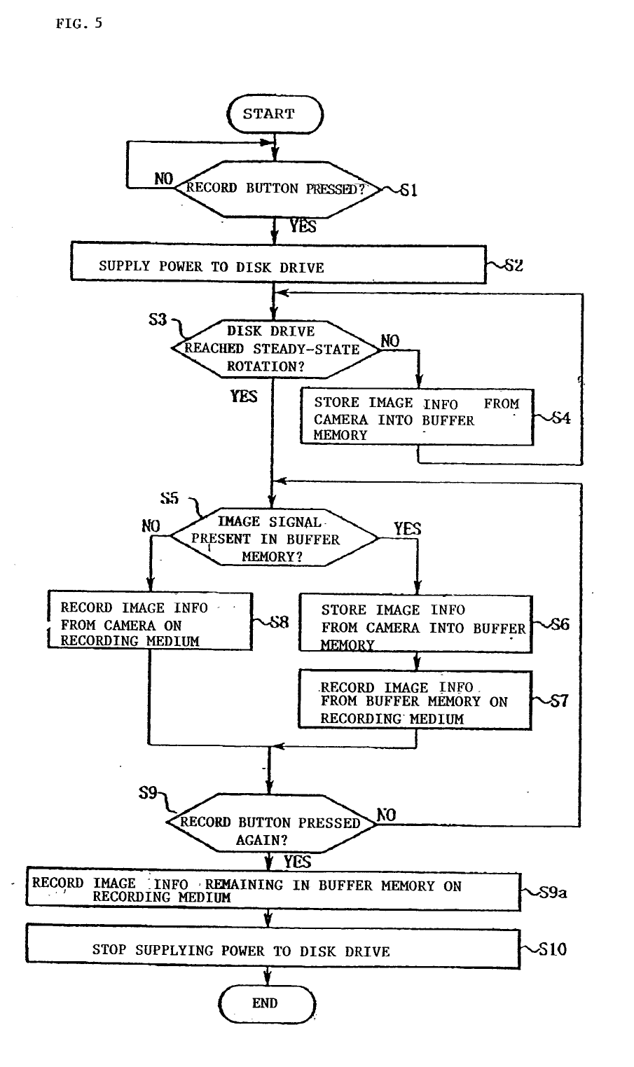

FIG. 5 is a flow chart for explaining the operation of the first embodiment. Referring to FIG. 3 through FIG. 5, the operation of the first embodiment will be explained.

When the record button 23 is pressed (S1 in FIG. 5), the microprocessor 24 generates a command to apply a power supply voltage from a battery (not shown) to the disk drive 20 (S2 in FIG. 5) to activate the drive. In this state, the microprocessor 24 monitors the rate of rotation, for example, of the disk drive 20 to determine whether or not the magneto-optical recording medium 21 has reached steady-state rotation (S3 in FIG. 5).

If the magneto-optical recording medium 21 has not reached steady-state rotation, the microprocessor 24 sequentially stores image information (data) of an image signal from the camera 11a into the buffer memory 19 (S4 in FIG. 5). This operation is repeatedly executed until the magneto-optical recording medium 21 reaches steady-state rotation.

If the magneto-optical recording medium 21 has reached steady-state rotation (S3 in FIG. 5), on the other hand, the microprocessor 24 determines whether any image information is stored in the buffer memory 19 (S5 in FIG. 5). When image information is present in the buffer memory 19, the microprocessor 24 continues recording image information from the camera 11a into the buffer memory 19 (S6 in FIG. 5). The microprocessor 24 then selects the second input terminal of multiplexer for receiving image information from the buffer memory, and writes the image information from the buffer memory 19 onto the magneto-optical recording medium 21 in chronological order (S7 in FIG. 5).

By repeating the above operation, the image information is passed through the buffer memory 19 in a first-in-first-out (FIFO) order, and sequentially stored on the recording medium 21. Since the quantity of data sequentially written on the recording medium per unit time is larger than that of the image signal generated from the data compressing unit 16, the amount of image information in the buffer memory 19 is reduced with the passage of time.

It is desirable that the buffer memory 19 have a storage capacity sufficient to store information of the image signal during the time required for the magneto-optical recording medium 21 to reach steady-state rotation with the minimum power supply voltage that renders the disk drive 20 operable. It is also desirable that the storage capacity of the buffer memory 19 be large enough to store additional information of the image signal while image information is transferred from the buffer memory 19, taking account of variations in the quantity of data of the image signal with variations in the compression ratio.

When the buffer memory 19 runs out of image information as a result of the above operation (S5 in FIG. 5), the microprocessor 24 selects the first input terminal of multiplexer 18 for receiving further image information directly from the compressing unit 16, bypassing the buffer memory 19, so that the image information from the camera 11a is recorded directly onto the magneto-optical recording medium 21 (S8 in FIG. 5). This operation is repeatedly executed with the control flow returning to step S5.

When the record button 23 is pressed again (S9 in FIG. 5), the microprocessor 24 records any image information remaining in the buffer memory onto the magneto-optical recording medium 21 (S9a in FIG. 5).

After completion of the image-recording operation as described above, the microprocessor 24 stops applying the power supply voltage to the disk drive 20 (S10 in FIG. 5).

In the above-described operation of the first embodiment, information of the head portion of the image signal is recorded in the magneto-optical recording medium 21 via the buffer memory 19, thus permitting image information of the entire image signal to be recorded without missing the head portion. Also, since the power supply voltage is applied to the disk drive 20 only during the period of the recording operation, the power consumption can be significantly reduced, and the service life of the battery can be extended considerably.

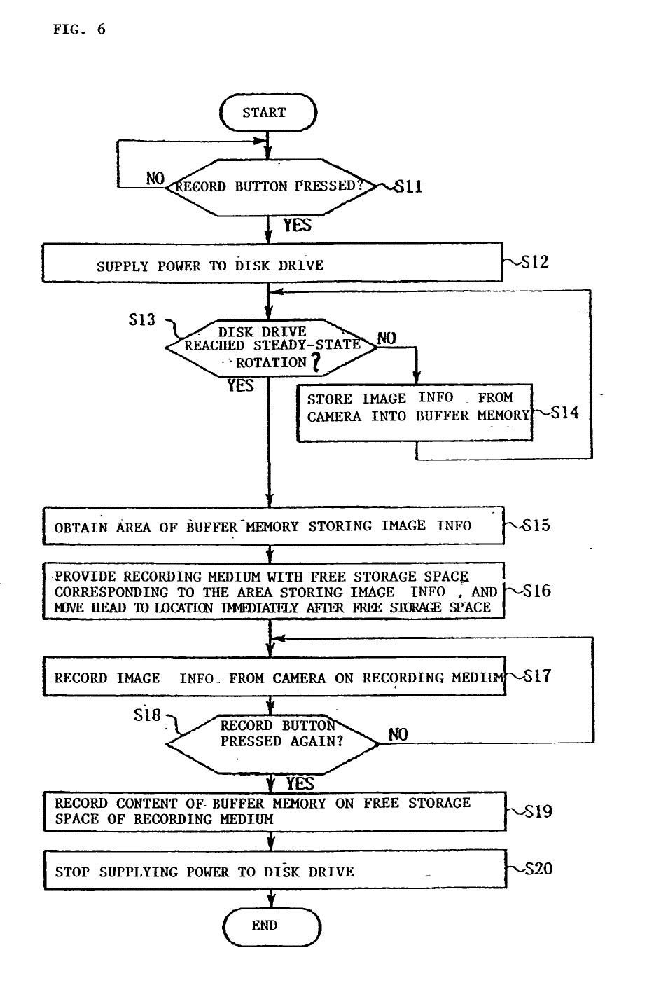

FIG. 6 is a flow chart showing the operation of a second embodiment of the invention. The arrangement of the second embodiment is identical to that of the first embodiment shown in FIG. 3. However, part of the functions of the microprocessor 24 differ.

The operation of the second embodiment will be explained referring to FIG. 3 and FIG. 6.

When the record button 23 is pressed (S11 in FIG. 6), the microprocessor 24 generates a command to apply the power supply voltage to the disk drive 20 (S12 in FIG. 6).

In this state, the microprocessor 24 monitors the rate of rotation of the disk drive 20 to determine whether or not the magneto-optical recording medium 21 has reached steady-state rotation (S13 in FIG. 6). If the magneto-optical recording medium 21 has not reached steady-state rotation, the microprocessor 24 sequentially records image information of the image signal from the camera 11a to the buffer memory 19 (S14 in FIG. 6). This operation is repeatedly executed until the magneto-optical recording medium 21 reaches steady-state rotation.

When the magneto-optical recording medium 21 has reached steady-state rotation (S13 in FIG. 6), the microprocessor 24 obtains the area of the buffer memory 19 in which image information of the image signal is stored (S15 in FIG. 6). The microprocessor 24 then controls the disk drive 20 to provide the magneto-optical recording medium 21 with a free storage space corresponding to the aforementioned area in the buffer memory 19. Then, the microprocessor causes the head of the disk drive 20 to move to a location immediately after the free storage space (S16 in FIG. 6). In this state, the microprocessor 24 selects the first input terminal of the multiplexer 18, and records the image information from the camera 11a directly onto the magneto-optical recording medium 21, bypassing the buffer memory 19 (S17 in FIG. 6). This recording operation is repeatedly executed until the record button 23 is pressed again (S18 in FIG. 6).

When the record button 23 is pressed again during the above operation (S18 in FIG. 6), the microprocessor 24 selects the second input terminal of the multiplexer 18, and writes the image information stored in the buffer memory 19 onto the magneto-optical recording medium 21. This information is written in chronological order in the free storage space previously provided (S19 in FIG. 6).

After completion of the picture-recording operation as described above, the microprocessor 24 stops applying the power supply voltage to the disk drive 20 (S20 in FIG. 6).

The image recording apparatus of the second embodiment which operates in the manner as described above yields substantially the same effects as provided in the first embodiment.

Further, the apparatus of the second embodiment is particularly advantageous in that the image information of moving pictures can be suitably arranged in chronological order on the magneto-optical recording medium 21. When an image reproducing apparatus or the like reads out image information from the magneto-optical recording medium 21, its reproducing head can therefore be moved with higher efficiency, with less waste, and the readout speed of the image information can be increased. Since the free storage space is provided in advance on the magneto-optical recording medium 21, there is no possibility of running out of recording space for the head portion of the image information while further image information is directly recorded onto the medium 21, which would lead to missing the head portion of the image information when it is reproduced.

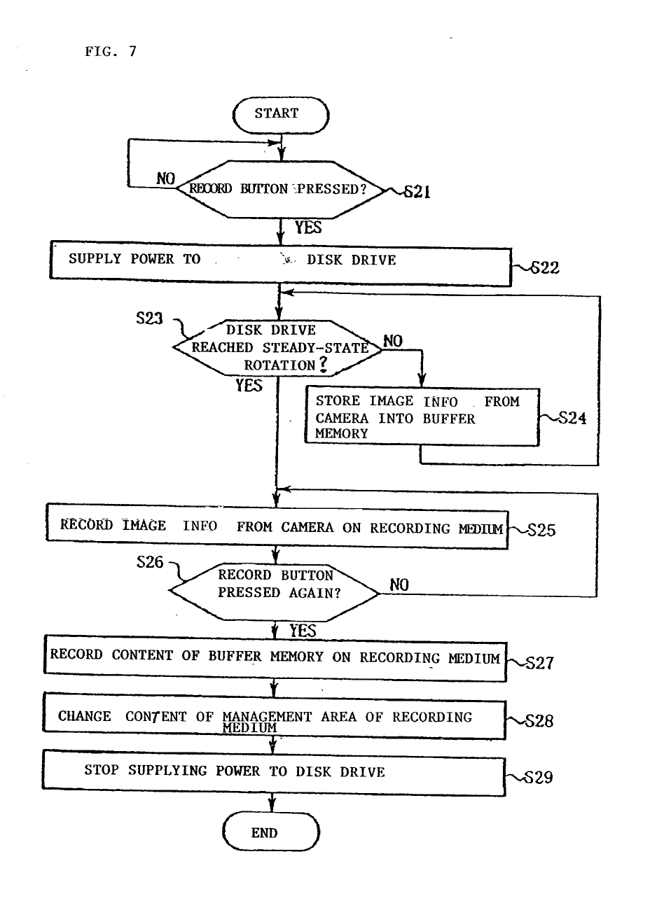

FIG. 7 is a flow chart illustrating the operation of a third embodiment of the present invention.

The arrangement of the third embodiment is identical to that of the first embodiment shown in FIG. 3. However, part of the functions of the microprocessor 24 differ in order to provide changing means as previously mentioned in connection with FIG. 1B. In the third embodiment the disk drive 20 and microprocessor 24 correspond to the changing means 5 in FIG. 1B.

The operation of the third embodiment will be now explained referring to FIG. 3 and FIG. 7.

When the record button 23 is pressed (S21 in FIG. 7), the microprocessor 24 generates a command to apply the power supply voltage to the disk drive 20 (S22 in FIG. 7).

In this state, the microprocessor 24 monitors the rate of rotation of the disk drive 20 to determine whether or not the magneto-optical recording medium 21 has reached steady-state rotation (S23 in FIG. 7). If the magneto-optical recording medium 21 has not reached steady-state rotation, the microprocessor 24 sequentially records image information of the image signal from the camera 11a into the buffer memory 19 (S24 in FIG. 7). This operation is repeatedly executed until the magneto-optical recording medium 21 reaches steady-state rotation.

When the magneto-optical recording medium 21 has reached steady-state rotation (S23 in FIG. 7), the microprocessor 24 selects the first input terminal of the multiplexer 18 for receiving data to be output from the multiplexer, and records the image information from the camera 11a directly onto the magneto-optical recording medium 21 (S25 in FIG. 7), bypassing the buffer memory 19. This recording operation is repeatedly executed until the record button 23 is pressed again (S26 in FIG. 7).

If the record button 23 is pressed again during the repeated operations (S26 in FIG. 7), the microprocessor 24 selects the second input terminal of the multiplexer 18 for receiving data to be output from the multiplexer, and writes the image information stored in the buffer memory 19 onto the magneto-optical recording medium 21, in chronological order (S27 in FIG. 7).

Subsequently, the microprocessor 24 rewrites a file allocation table (FAT) of the magneto-optical recording medium 21, which is a data management area of the medium that is used to control the order in which recorded information is read out. The microprocessor rewrites the FAT so that the last cluster number of the storage area in which the image information from the buffer memory 19 was recorded is followed by the first cluster number of the storage area in which image information was directly recorded (S28 in FIG. 7). Upon completion of the rewriting operation, the microprocessor 24 stops supplying the power supply voltage to the disk drive 20 (S29 in FIG. 7).

The image recording apparatus of the third embodiment which operates in the manner as described above yields substantially the same effects as provided in the first embodiment.

Further, the apparatus of the third embodiment is particularly advantageous in that the image information is reproduced in the right order owing to rewriting of the FAT after recording. As compared with the earlier described technique of providing a free space, the technique of the third embodiment avoids the need for special processing during the recording operation, which is advantageous when recording information that must be processed at high speed.

While the apparatus and methods of the invention have been exemplified by the preferred embodiments described above, it will be apparent to those skilled in the art that numerous variations are possible in keeping with the basic principles of the invention. For example, the apparatus may conveniently include additional elements, such as an interface for connection to a personal computer or the like, and a video signal output for connection to a home picture-reproducing apparatus such as a TV-monitor.

Also, while a magneto-optical recording medium 21 is used as a recording medium in the illustrative embodiments, the broader principles of the present invention are not limited to any particular material, shape, or structure of recording medium, and any type of recording medium capable of recording image information may be used. For example, the recording medium may be an optical recording medium or a magnetic recording medium instead of a magneto-optical medium. Also, the recording medium may be a tape medium, for example, instead of a disk. Particularly, in the second and third embodiments, however, disk media that generally ensure high random access performance are preferred.

Further, while the image information is recorded from the moment that the record button 23 is operated in the illustrative embodiments, the recording of the image information need not be started at this moment. For example, the microprocessor 24 may record image information in the buffer memory 19 before the record button 23 is operated. In this arrangement, the image information obtained during a period of delay in the operation of the record button 23 (a period of several milliseconds to several seconds that varies depending upon the responsiveness of the operator) can be recorded without fail. Accordingly, a problem of missing a great picture-taking opportunity can be surely avoided.

Further still, while the determination as to whether the magneto-optical recording medium 21 has reached steady-state rotation is made by monitoring the rate of rotation of the disk drive 20 in the illustrative embodiments, the present invention is not limited to this method. For example, the time required for the recording medium 21 to reach steady-state rotation once power is supplied may be determined in advance based on actual measurements or the like, and the microprocessor may determine that the steady-state rotation has been achieved based upon a lapse of the required time.

Further still, while the record button in the form of a toggle switch is used to start and finish image recording in the illustrative embodiments, the present invention is not limited to this arrangement. For example, the record button may be displayed on a finder or monitor screen, and the record button displayed on the screen may be operated through an input device, such as a touch panel or a mouse. It is also possible to continue a recording operation by keeping the record button pressed, and to finish the recording operation by releasing the record button.

It is additionally possible within the broad principles of the invention to record all image information to the main information storage medium through the intermediary of the preliminary storage unit, without the bypass recording operation described above. In such case, a system similar to that of FIG. 2 can be employed in which the direct input of image information to the control unit is omitted, so that all image information is input to the preliminary storage unit 3. The control unit 50 would control the preliminary storage unit 3 and the drive unit 60 so that image information is stored by the preliminary storage unit during a first period of time, in which the drive unit 60 is brought to the proper operating state for recording information, whereafter the transfer of image information to the drive unit for recording on the recording medium 1 would be initiated. Also, as further image information is generated, it would be stored temporarily in the preliminary storage unit 3 and transferred to the drive unit 60 for recording on the recording medium 1.

In a practical application to a camera system, for example, an apparatus as just described an readily be implemented by modifying the arrangement in FIG. 3 so as to omit the multiplexer 18 and to route all of the image information from the data compressing unit 16 to the disk drive 20 via the buffer unit 19, the output of which would be connected to the disk drive without the intermediary of the multiplexer. The control functions of the microprocessor 24 would be modified so that all of the image information associated with an image recording operation, including header information generated before steady-state rotation of the disk drive and subsequently generated image information of the image signal, is stored in the buffer memory 19 and then transferred to the disk drive 20 in sequence (FIFO). The transfer operation would be initiated after the disk drive has reached steady-state rotation. By storing image information in the buffer memory 19 while the disk drive 20 is brought to the steady state for recording image information, this system can provide the earlier discussed advantages of reduced power consumption and reduced cumulative operating time of the disk drive.

It will be appreciated, of course, that the variations just described are merely exemplary and that numerous other variations are possible within the scope of the invention as defined in the accompanying claims.

The invention claimed is:

1. An image recording apparatus, comprising:
first recording means having a predetermined operating state in which said first recording means is capable of recording image information of an image signal to an information storage medium;
a preliminary storage unit that stores image information of the image signal while said first recording means is being brought to said predetermined operating state; and
additional recording means that records the image information stored by said preliminary storage unit to said storage medium after said first recording means has been brought to said predetermined operating state;
said first recording means operating to record further image information of the image signal to said storage medium, bypassing said preliminary storage unit, after reaching said predetermined operating state.

2. Apparatus according to claim 1, further comprising a camera unit to generate said image signal .

3. Apparatus according to claim 2, wherein said information storage medium is a dynamic information storage medium, and said first recording means includes a writing device to write information to said dynamic storage medium and a drive for causing relative movement between said dynamic storage medium and said writing device.

4. Apparatus according to claim 3, wherein said predetermined operating state is a state in which a rate of relative movement between said dynamic storage medium and said writing device is stable.

5. Apparatus according to claim 3, further comprising control means that detects a parameter related to relative movement between said dynamic storage medium and said writing device, determines whether said first recording means has been brought to said predetermined operating state based on the detection result, and controls said first recording means, said additional recording means, and said preliminary storage unit based on the determination result.

6. Apparatus according to claim 5, wherein said dynamic storage medium is a disk, and said parameter indicates one of a revolution rate of said disk relative to said writing device and an elapsed time following commencement of relative movement between said disk and said writing device.

7. Apparatus according to claim 3, wherein after said first recording means has reached said predetermined operating state, said additional recording means transfers image information from said preliminary storage unit to said dynamic storage medium at a relatively fast rate while said preliminary storage unit continues storing image information of said image signal at a relatively slow rate, and said first recording means commences recording said further image information after all of the image information recorded in said preliminary storage unit has been transferred.

8. Apparatus according to claim 3, wherein said first recording means provides a free space in a head region of an area of said dynamic storage medium to which said further image information is recorded, and said additional recording means records the image information stored by said preliminary storage unit to said free space after said first recording means records said further image information to said dynamic storage medium.

9. Apparatus according to claim 3, wherein said additional recording means records the image information stored by said preliminary storage unit to said dynamic storage medium after said first recording means records said further information to said dynamic storage medium,
said apparatus further comprising means operating to change content of a data management area of said dynamic storage medium that controls an order in which information is read out from that medium, so that the image information recorded from said preliminary storage unit is read out followed by said further information.

10. Apparatus according to claim 3, wherein said dynamic storage medium is a disk.

11. Apparatus according to claim 10, and which is portable and battery-powered.

12. Apparatus according to claim 10, wherein said preliminary storage unit is a static buffer memory.

13. Apparatus according to claim 12, wherein said predetermined operating state is a state in which a revolution rate of said disk relative to said writing device is stable.

14. Apparatus according to claim 13, wherein said drive rotates said disk.

15. Apparatus according to claim 12, wherein said disk is one of a magneto-optical disk, and optical disk, and a magnetic disk.

16. Apparatus according to claim 12, wherein said drive is inactive until initiation of an image recording operation.

17. Apparatus according to claim 16, further comprising a manually operable member to initiate said image recording operation.

18. Apparatus according to claim 17, wherein said manually operable member is a touch screen that displays an image taken by the camera unit.

19. An image recording apparatus, comprising:
a preliminary information storage unit;
a main information storage unit; and
a control unit that controls said information storage units such that said preliminary information storage unit records image information of an image signal during a first period of time, and such that, during a subsequent period of time, said main information storage unit records further image information of said image signal, bypassing said preliminary information storage unit, and said main information storage unit records image information from said preliminary information storage unit.

20. Apparatus according to claim 19, wherein said main storage unit records to a dynamic storage medium and includes a writing device to write image information to said dynamic storage medium and a drive for causing relative movement between said dynamic storage medium and said writing device.

21. Apparatus according to claim 20, wherein said first period of time is a period in which said drive is brought to a stable operating state for recording information.

22. Apparatus according to claim 21, wherein said control unit controls said storage units such that, during said subsequent period of time, said preliminary storage unit transfers image information to said main storage unit at a relatively fast rate while continuing to record image information of said image signal at a relatively slow rate, and said main storage unit commences recording said further image information when all of the image information recorded in said preliminary storage unit has been transferred.

23. Apparatus according to claim 21, wherein said control unit controls said information storage units such that said main storage unit provides a free space in a head region of an area of said dynamic storage medium to which said further image information is recorded, and said main storage unit records image information from said preliminary storage unit to said free space after said further image information is recorded.

24. Apparatus according to claim 21, wherein said control unit controls said storage units such that said main storage unit records image information from said preliminary storage unit after said further image information is recorded, and said control unit causes content of a data management area of said dynamic storage medium that controls an order of information read out from that medium to be changed, so that the image information recorded from said preliminary storage unit is read out followed by said further image information.

25. Apparatus according to claim 21, wherein said control unit detects a parameter related to the operating state of said main storage unit, determines whether said main storage unit has been brought to said stable operating state based on the detection result, and controls said preliminary storage unit and said main storage unit based on the determination result.

26. Apparatus according to claim 21; wherein said dynamic storage medium is a disk.

27. Apparatus according to claim 26, wherein said predetermined operating state is a state in which a revolution rate of said disk relative to said writing device is stable.

28. Apparatus according to claim 27, wherein said drive rotates said disk.

29. Apparatus according to claim 26, wherein said disk is one of a magneto-optical disk, an optical disk, and a magnetic disk.

30. Apparatus according to claim 21, further comprising a camera unit to generate said image signal.

31. Apparatus according to claim 30, and which is portable and battery-powered.

32. Apparatus according to claim 31, wherein said control unit maintains said drive in, an inactive state until initiation of an image recording operation.

33. Apparatus according to claim 32, wherein said preliminary storage unit is a static buffer memory.

34. Apparatus according to claim 32, further comprising a manually operable member to initiate said image recording operation.

35. Apparatus according to claim 34, wherein said manually operable member is a touch screen that displays an image taken by the camera unit.

36. An image recording method, comprising:
generating an image signal;
recording image information of said image signal to a preliminary storage medium during a first period of time; and
during a subsequent period of time, recording further image information of said image signal to a main storage medium, bypassing said preliminary storage medium, and recording image information from said preliminary storage medium to said main storage medium.

37. A method according to claim 36, wherein said image signal is generated by a camera unit.

38. A method according to claim 37, and which is applied in a portable, battery-powered camera system.

39. A method according to claim 36, wherein said main storage medium is a dynamic storage medium.

40. A method according to claim 39, wherein said dynamic storage medium is a disk.

41. A method according to claim 39, wherein said preliminary storage medium is a static buffer memory.

42. A method according to claim 39, wherein said first period is a time period in which a stable state of relative movement is established between said dynamic storage medium and a writing device that writes information to said dynamic storage medium.

43. A method according to claim 42, further comprising detecting a parameter related to relative movement between said dynamic storage medium and said writing device, determining whether said stable state has been established, and controlling recording of image information to said preliminary storage medium and recording of image information to said main storage medium based on said determining.

44. A method according to claim 43, wherein said dynamic storage medium is a disk, and said parameter indicates one of a revolution rate of said disk relative to said writing device and an elapsed time following commencement of relative movement between said dynamic storage medium and said writing device.

45. A method according to claim 42, said method further comprising continuing to record image information of said image signal to said preliminary storage medium at a relatively slow rate while transferring image information from said preliminary storage medium to said dynamic storage medium storage medium during said subsequent period, and commencing said recording of further image information after all of the image information recorded to said preliminary storage medium has been transferred.

46. A method according to claim 42, further comprising providing a free space in a head region of an area of said dynamic storage medium to which said further information is recorded, and wherein the information recorded from said preliminary storage medium is recorded to said free space after said further information is recorded.

47. A method according to claim 42, wherein said recording of image information from said preliminary storage medium is conducted after said further information is recorded to said dynamic storage medium, and further comprising changing content of a data management area of said dynamic storage medium that controls an order in which information is read out from that medium, so that the image information recorded from said preliminary storage medium is read out followed by said further image information.

48. An operating method of an image recording apparatus including a camera unit and an information storage unit for recording image information of an image signal from said camera unit on a disk, said method comprising:
initiating an operation to record image information of the image signal on said disk;
activating said information storage unit in response to initiation of the operation;
recording image information of said image signal in a buffer unit at least until said information storage unit reaches a stable operating state for recording information to said disk; and
after said information storage unit has reached the stable operating state, recording further image information of said image signal on said disk, bypassing said buffer unit, and transferring image information from said buffer unit to said disk.

49. A method according to claim 48, further comprising detecting a parameter indicating an operating condition of said information storage unit, and determining whether said information storage unit has reached said stable operating state based on said detecting.

50. A method according to claim 49, wherein the detected parameter indicates a relative movement between said disk and a writing device that writes information on said disk.

51. A method according to claim 50, wherein the detected parameter indicates one of a relative revolution rate of said disk and said writing device and an elapsed time following activation of said information storage unit.

52. A method according to claim 49, comprising continuing to record image information in said buffer unit during said transferring of information to said disk, said transferring being conducted at a faster rate than recording in said buffer unit, and commencing said recording of further image information when said buffer unit is empty.

53. A method according to claim 49, further comprising providing a free space in a head region of an area of said disk in which said further information is recorded, and wherein image information transferred from said buffer unit is recorded in said free space after said further image information is recorded.

54. A method according to claim 49, wherein said transferring is conducted after said further information is recorded on said disk, and further comprising changing content of a data management area of said disk that controls an order in which information is read out from said disk, so that the transferred image information is read out followed by said further image information.

55. A method according to claim 49, wherein said image recording apparatus is a portable, battery-powered apparatus.

56. An image recording apparatus, comprising:
a preliminary information storage unit;
a main information storage unit having a predetermined operating state in which said main information storage unit is capable of recording image information; and
a control unit which controls said information storage units such that said preliminary information storage unit records image information of an image signal, at least during a period of time in which said main information storage unit is being brought to said predetermined operating state, and said main information storage unit records image information of said image signal from said preliminary information storage unit after said main information storage unit has reached said predetermined operating state.

57. An image recording method, comprising:
generating an image signal;
recording image information of the image signal in a preliminary information storage unit at least during a period of time in which a main information storage unit is being brought to a predetermined operating state in which it is capable of recording image information; and
recording image information of the image signal from said preliminary information storage unit in said main information storage unit after said main information storage unit has reached said predetermined operating state.
